(19) United States
(12) Patent Application Publication
(10) Pub. No.: US 2006/0180271 A1
(43) Pub. Date: Aug. 17, 2006

(54) Optical recording medium and manufacturing method thereof

(75) Inventors: Ryuichi Yokoyama, Yokohama-shi (JP); Kuniyuki Morita, Yokohama-shi (JP); Masahito Konishi, Yokohama-shi (JP); Kyosuke Deguchi, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/345,300

(22) Filed: Feb. 2, 2006

(30) Foreign Application Priority Data
Feb. 14, 2005 (JP) 2005-036110
May 27, 2005 (JP) 2005-155533

(51) Int. Cl. B32B 37/00

(52) U.S. Cl. 156/269; 156/280

(57) ABSTRACT

A method of manufacturing an optical recording medium is provided, which is capable of manufacturing a highly reliable optical recording medium, an eccentricity of each recording layer formed on each of a plurality of sheet-like substrates may be suppressed, and which does not involve a complicated process. Specifically, a plurality of sheet-like substrates are laminated by a laminating apparatus under the condition that a recording layer is formed on one surface of each of the plurality of sheet-like substrates, and an uncured adhesive layer is formed on the other surface thereof. The laminating apparatus performs centering of each sheet-like substrate before the process of curing the adhesive layers. Then, the adhesive layers are cured, and a punching apparatus punches the three-layered sheet-like substrates into a disk shape in a collective manner, thereafter.

### BACKGROUND OF THE INVENTION

1. Field of the Invention

The present invention relates to an optical recording medium having a multi-layered structure in which a plurality of sheet-like substrates each having a recording layer are laminated, and to a method of manufacturing the optical recording medium.

2. Related Background Art

Recently, an optical recording medium typified by an optical disk is being applied as a medium for recording various kinds of pieces of information in an audio visual field as well as a computer field. Further, as a result of spread of a mobile computer and advancement of diversification of information, there is a demand for a small optical recording medium with a large capacity.

Information is recorded or reproduced with respect to the optical recording medium by using light. Uneven patterns (hereinafter, referred to as “signal pattern”) such as pits and pre-grooves for obtaining a tracking servo signal and the like are formed on a substrate (sheet-like substrate). On a surface on which the uneven patterns are formed, i.e., the uneven pattern surface (also referred to as “information recording surface”), a recording layer is formed, and an organic protective layer or the like is further formed so as to cover the recording layer.

As the optical recording medium, there are known a single plate structure and a structure in which two sheet-like substrates are opposed and bonded together. Further, a recording medium with a multi-layered structure in which a plurality of recording layers are formed has also been proposed along with the demand for high-density recording. FIG. 9 shows an example of the multi-layered structure, and a plurality of recording layers 92 are formed via a transparent intermediate layer 94 or the like. On top of the recording layer 92 in the figure, an organic protective layer 93 is formed.

A light incident for recording/reproducing and erasing information may be made from either of a substrate 97 side or the organic protective layer 93 side. However, it is known that it is advantageous in terms of the enhancement of density to record/reproduce and erase information from the organic protective layer 93 side, because it is easy to make the thickness of a light transmissive layer, thereby being capable of enhancing a numerical aperture (NA) of an objective lens of a pickup.

The following documents disclose an optical recording medium having the above-mentioned multi-layered structure, and a manufacturing method thereof, or a method of forming a plurality of recording layers.

However, the conventional proposals according to the following documents have the following problems, respectively.

International Publication No. 98/02875 discloses a method of manufacturing an optical disk (optical recording medium) having a high mass-productivity, excellent optical characteristics, and excellent mechanical accuracy and mechanical strength. According to this method, a sheet made of a material containing a polyolefin polymer as a main component is formed into a disk shape, and an information recording surface made of curable resin is formed on the sheet. Further, International Publication No. 98/02875 proposes that a film made of curable resin, on which an information recording surface and a recording layer are formed, is formed on a sheet before being formed into a disk shape, and the resultant sheet is formed into a disk shape, thereafter. International Publication No. 98/02875 also proposes a method of manufacturing an optical recording medium having a multi-layered structure by laminating a plurality of sheets of light-curable resin having an information recording surface on a sheet formed into a disk shape.

The method of forming the curable resin layer having an information recording surface into a sheet as described in International Publication No. 98/02875 is a known technology, because a substrate material is merely limited by a photo polymerization method (2P method) that is a conventionally known manufacturing method.

Further, according to International Publication No. 98/02857, aligning (centering) of respective substrates each having an information recording surface is not taken into consideration. If the center of each substrate is not positioned with high accuracy in an optical disk, the eccentricity of the substrate may occur, which causes various inconveniences.

Japanese Patent Application Laid-Open No. H11-185291 proposes a recording medium having a structure in which a recording layer is formed on a sheet with a thickness of 0.3 μm or less, and a recording medium having a multi-layered structure in which a recording layer is formed on a support substrate having rigidity, and the sheet is bonded through the intermediation of a transparent intermediate layer.

A multi-layered structure formed by using such a thin sheet is advantageous because information can be recorded at high density. However, Japanese Patent Application Laid-Open No. H11-185291 considers only a two-layered structure in which a support substrate having a recording layer and a sheet are bonded together, or a hard disk type in which a recording layer is formed on both surfaces of an aluminum substrate.

Japanese Patent Application Laid-Open No. 2000-36135 proposes the following as a method of manufacturing an optical recording medium having a multi-layered structure. First, a signal surface (same as an information recording surface) is formed on a sheet, and a semi-transparent film is formed on the signal surface. Then, the sheet is punched out into a predetermined shape to produce a first substrate. A substrate having a signal surface is formed by injection molding or the like, and a reflective film is further formed on the substrate, to thereby produce a second substrate. Finally, the first and second substrates are bonded together through the intermediation of a transparent adhesive.

According to this method, substrates formed into predetermined contour shape are bonded together, so no problem seems to arise as long as the structure is a two-layered structure. However, in the case of forming a sheet or sheets as the intermediate layer(s) to obtain a multi-layered (three or more layered) structure, the sheet(s) for the intermediate layer(s) becomes thin (several μm to several tens of 82 m). Thus, it is difficult to handle the sheet, which causes a problem in terms of productivity. More specifically, a punched sheet is generally held at its end portion, and in the case of the thin sheet, a holding region (end portion) is very narrow.

Further, Japanese Patent Application Laid-Open No. 2000-36135 also describes that a sheet and a substrate are bonded together, and the layered body is punched into a disk shape, thereafter. However, this is strictly limited to a two-layered structure, and a multi-layered (three or more layered) structure is not taken into consideration.

Japanese Patent Application Laid-Open No. 2003-115130 proposes a multi-layered structure in which a sheet having a light-curable resin layer with a signal surface (which is the same as an information recording surface) and a reflective layer formed thereon is used as a substrate, and the substrates are bonded together in three or more layers via an adhesive, and also proposes a manufacturing method thereof.

This multi-layered structure has been proposed in order to solve such a problem that a transcription defect occurs in the case where a substrate thickness is 300 μm or less and is produced by injection molding. However, Japanese Patent Application Laid-Open No. 2003-115130 does not take punching of the sheet into consideration.

Further, as described above, if the sheet is thick, a sheet end portion or a non-effective region may be held with a clamp (for example, held mechanically or with a vacuum chuck), thereby being capable of holding the sheet satisfactorily. However, in the case of a multi-layered structure, it is necessary to set the thickness of each sheet to be several μm to several tens of μm, which is considered to make it difficult to hold the sheet. This means, for example, that thin sheets cannot be laminated satisfactorily in a bonding process.

Further, according to the manufacturing method of Japanese Patent Application Laid-Open No. 2003-115130, in the same way as in International Publication No. 98/02875, the 2P method that is a conventionally known manufacturing method is used, and a material for light-curable resin is merely limited. It is a known technology to produce an optical recording medium by forming a light-curable resin layer on a sheet.

Japanese Patent Application Laid-Open No. 2002-288894 proposes a method in which at least two light-transparent sheets are bonded onto a disk-shaped substrate with a reflective layer and the like formed on a signal surface, and punching those sheets into a disk shape. This manufacturing method is characterized in that, after the sheets are bonded onto the substrate, film formation is performed with respect to the sheets to form the signal surface. In the case of manufacturing a multi-layered structure by this manufacturing method, it is necessary to repeat (1) to (4) steps: (1) bonding sheets; (2) forming a signal surface on the sheets; (3) punching the sheets into a disk shape; and (4) forming a recording layer on the signal surface, on one substrate. Therefore, production process is complicated, which is disadvantageous for enhancing productivity. More specifically, the manufacturing method described in Japanese Patent Application Laid-Open No. 2002-288894 puts emphasis on the production of an optical recording medium with a two-layered structure, and is not suitable for manufacturing a multi-layered structure of three or more layers.

The present invention has been made in view of the above-mentioned problems. An object of the present invention is to provide a method of manufacturing an optical recording medium, which is capable of manufacturing a highly reliable optical recording medium, an eccentricity of each recording layer formed respectively on a plurality of sheet-like substrates may be suppressed, and which does not involve a complicated process. Further, another object of the present invention is to provide a highly reliable optical recording medium, in which the eccentricity of each recording layer formed on respectively on a plurality of sheet-like substrates may be suppressed.

### SUMMARY OF THE INVENTION

The present invention provides a method of manufacturing an optical recording medium, which is capable of manufacturing a highly reliable optical recording medium, an eccentricity of each recording layer formed respectively on a plurality of sheet-like substrates may be suppressed, and which does not involve a complicated process.

Specifically, a method of manufacturing a recording medium according to the present invention includes the steps of:

forming a recording layer having uneven patterns on a surface of a sheet-like substrate;

laminating a plurality of the sheet-like substrates having the recording layer formed thereon in an aligning manner; and

processing the plurality of laminated sheet-like substrates into a predetermined contour shape in a collective manner.

### BRIEF DESCRIPTION OF THE DRAWINGS

FIG. 1 is a cross-sectional view schematically showing an example of a structure of an optical recording medium produced by a manufacturing method of the present invention.

FIG. 2 is a perspective view schematically showing the optical recording medium of FIG. 1.

FIG. 3 is a view schematically showing a forming apparatus or the like forming a signal pattern.

FIGS. 4A, 4B, and 4C are views schematically showing a structure of an apparatus forming an adhesive layer on a sheet-like substrate.

FIG. 5 is a view schematically showing a laminating apparatus or the like for laminating a plurality of sheet-like substrates.

FIG. 6 is a plan view showing an alignment mark on a sheet-like substrate.

FIGS. 7A, 7B, 7C, 7D, and 7E are views showing a production process according to this embodiment of the present invention.

FIGS. 8A, 8B, 8C, 8D, 8E, and 8F are views showing a production process of a stamper.

FIG. 9 is a cross-sectional view showing an example of a structure of a conventional optical recording medium.

FIGS. 10A and 10B are schematic cross-sectional views of an optical recording medium in which a protective layer is formed using a sheet.

FIGS. 11A, 11B, 11C, and 11D are schematic views showing a process of forming a protective layer using sheets.

FIGS. 12A, 12B, 12C, 12D, and 12E are schematic views showing a process of forming a protective layer by immersing the disk in resin.

### DESCRIPTION OF THE PREFERRED EMBODIMENTS

Hereinafter, the present invention will be described by way of an embodiment with reference to the drawings.

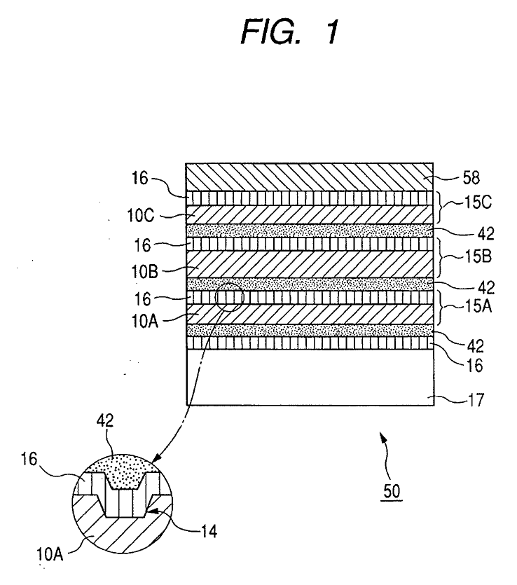

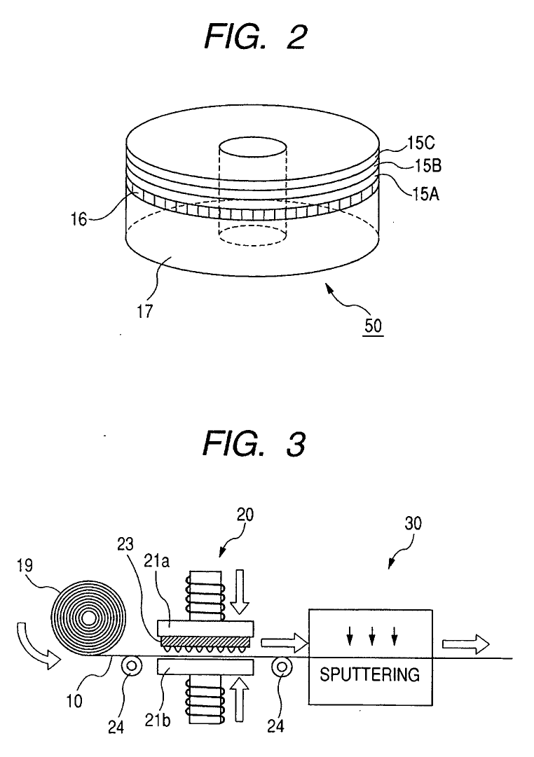

FIG. 1 is a cross-sectional view schematically showing an exemplary structure of an optical recording medium produced by a manufacturing method of the present invention. FIG. 2 is a perspective view schematically showing the optical recording medium of FIG. 1. As shown in FIGS. 1 and 2, an optical recording medium 50 that is an optical disk includes a transparent support substrate 17 composed of, for example, polycarbonate as a base, and three-layered information recording substrates 15A, 15B, and 15C successively laminated on the support substrate 17. On a surface of the information recording substrate 15C on an uppermost side, a protective layer 58 is formed.

Each of the information recording substrates 15A to 15C has a recording layer 16, and one-layered recording layer 16 is also formed on the surface of the support substrate 17. Thus, the optical recording medium 50 of this embodiment has a structure (four-layered structure) having four recording layers 16. Then, the reproduction of information of each layer can be performed by irradiating each recording layer 16 with laser light, for example, from the protective layer 58 side, and reading a change in reflected light.

The main purpose of the manufacturing method described in this embodiment is to suppress the eccentricity of the recording layer 16 of each of the information recording substrates 15A to 15C, and thus, the recording layer 16 on the support substrate 17 may not be present.

The respective information recording substrates 15A, 15B, and 15C are composed of sheet-like substrates 10A, 10B, and 10C (hereinafter, these will be collectively referred to as a “sheet-like substrate 10”) with the recording layer 16 formed on the surface. The structures of the information recording substrates 15A, 15B, and 15C are substantially the same, so that the information recording substrate 15A will be illustrated hereinafter.

In the information recording substrate 15A, the sheet-like substrate 10A is, for example, a polycarbonate sheet material with a thickness of about 15 μm. On the surface thereof, an uneven signal pattern 14 is formed (see an enlarged view in a circle). On the surface of the signal pattern 14, the recording layer 16 formed, for example, by sputtering is formed. The recording layer 16 is a thin film with a thickness of about 10 nm, for example. Therefore, the recording layer 16 also has an uneven shape corresponding to the unevenness of the signal pattern 14. Further, the recording layer 16 on the surface of the support substrate 17 is also configured in the same way as in the recording layer 16 of the recording information substrate 15A.

An optical disk is roughly classified into a reproduction-only type, a write-once type capable of recording only once, and a rewritable type capable of rewriting information. Depending upon the type, the name of a layer for recording information may vary. For example, in the write-once type and the rewritable type, a layer for recording is called a recording layer. In contrast, in the case of the reproduction-only type, information is composed of formed pits, and a reflective layer is formed on the pits. Although this reflective layer cannot perform recording, the “recording layer” in the present specification also includes such a “reflective layer” in terms of the interpretation.

An adhesive layer 42 is formed between the support substrate 17 and the information recording substrate 15A, and between the respective information recording substrates, whereby the substrates are bonded to each other. As an adhesive, for example, a thermosetting adhesive, a 2-liquid adhesive, a hot-melt adhesive, or a pressure-sensitive adhesive is preferable. As the protective layer 58, for example, UV-curable resin can be used.

Next, some apparatuses for manufacturing the above-mentioned optical recording medium 50 will be described with reference to FIGS. 3, 4A to 4C and 5.

FIG. 3 shows a forming apparatus 20 for forming a signal pattern on the sheet-like substrate 10, a film-forming apparatus 30 for forming a recording layer on a signal pattern, a roller 24 that is means for transporting the sheet-like substrate 10, and the like.

The forming apparatus 20 includes a stamper 23 for forming a predetermined uneven pattern on one surface of the long sheet-like substrate 10 pulled out from a roll 19, and a pair of support members 21a and 21b for sandwiching the sheet-like substrate 10. The stamper 23 is a precision die bonded to one of support members 21a, which is configured so as to be heated by heating means (not shown). In the forming apparatus 20 thus configured, under the condition that the stamper 23 is being heated, the pair of support members 21a and 21b are driven to sandwich the sheet-like substrate 10. The sheet-like substrate 10 is pressed and heated, whereby uneven patterns (signal patterns) are transcribed to the surface of the sheet-like substrate 10.

The forming apparatus 20 may have means for cooling the sheet-like substrate 10 with uneven patterns transcribed thereon, if required. Further, the forming conditions such as a heating temperature, a pressure force, a cooling time, and the moving distance of the stamper 23 in the transcription process are not particularly limited, and optimum conditions may be selected appropriately, considering the shape of a signal pattern, the material quality of the sheet-like substrate 10, the thickness of a sheet, and the like.

The forming apparatus 30 is a sputtering apparatus for forming the recording layer 16 on the surface of a signal pattern of the transported sheet-like substrate 10. The forming apparatus 30 is not limited to the one for performing sputtering, and may be other various forming apparatuses. The detail thereof will be described later.

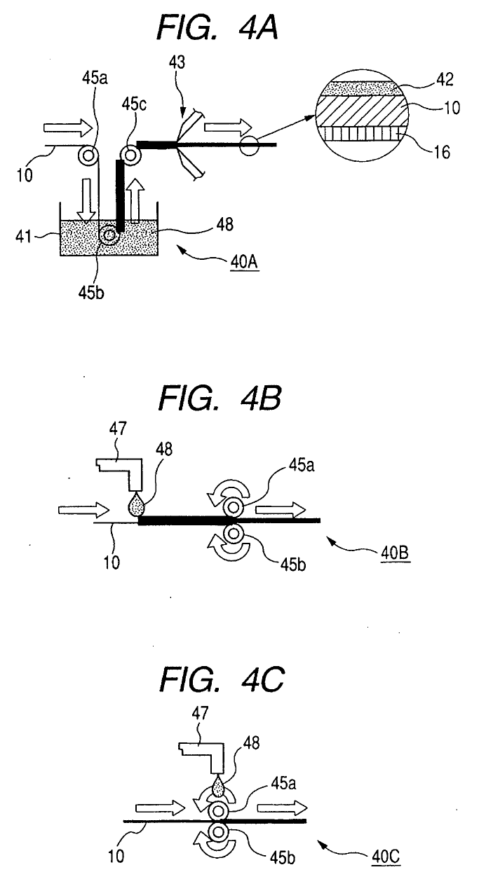

FIGS. 4A to 4C show exemplary apparatuses for forming the adhesive layer 42 on the sheet-like substrate 10, and adhesive coating apparatuses 40A, 40B, and 40C having different structures are shown respectively in FIGS. 4A, 4B, and 4C.

The adhesive coating apparatus 40A has rollers 45a, 45b, and 45c for transporting the sheet-like substrate 10 with the recording layer 16 formed thereon. Among them, one roller 45b is placed in a tank 41 filled with an uncured adhesive 48. Because of this, the adhesive 48 adheres to both surfaces of the sheet-like substrate 10 having passed through the roller 45b. The adhering adhesive 48 is adjusted to a predetermined thickness by blades 43 opposed to each other with the sheet-like substrate 10 placed therebetween. In this embodiment, the adhesive on the recording layer 16 side is removed completely, and the adhesive layer 42 with a predetermined thickness (e.g., about several μm) is allowed to remain on an upper surface side of the sheet-like substrate 10 of the figure (see an enlarged view in a circle). The blade 43 may be composed of a doctor knife or the like.

Apparatuses as shown in FIGS. 4B and 4C may be used in place of the adhesive coating apparatus 40A. In the adhesive coating apparatus 40B shown in FIG. 4B, a pair of rollers 45a and 45b are opposed to each other with the sheet-like substrate 10 placed therebetween. On an upstream side of the rollers 45a and 45b, a nozzle 47 for supplying the adhesive 48 to an upper surface of the sheet-like substrate 10 is placed. A lower surface side of the sheet-like substrate 10 is the recording layer 16 in the same way as in the above structure. The adhesive 48 on the upper surface of the sheet-like substrate supplied from the nozzle 47 is pressed with the rollers 45a and 45b while passing therethrough to become an adhesive layer 42 with a predetermined thickness. The adhesive coating apparatus 40C is obtained by deforming the above-mentioned adhesive coating apparatus 40B, and has a structure in which the nozzle 47 is placed above the rollers 45a and 45b, and the adhesive 48 from the nozzle 47 is supplied directly to the roller 45a.

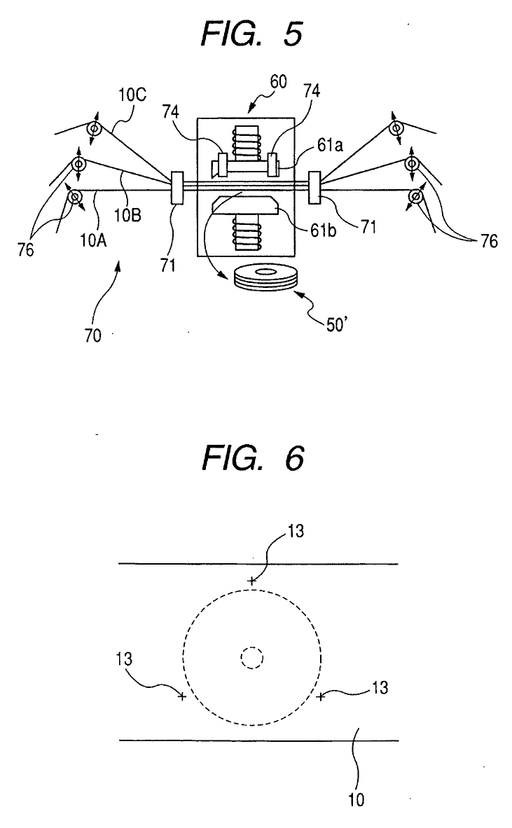

FIG. 5 shows a laminating apparatus 70 for laminating the sheet-like substrate 10 in three layered, in which a recording layer and an adhesive layer are formed when the sheet-like substrate 10 passes through the above-mentioned various kinds of apparatuses 20, 30, 40, and the like, and a punching apparatus 60 for punching the three-layered sheet-like substrates 10A to 10C into a disk shape. The laminating apparatus 70 includes a plurality of tension rollers 76 for transporting the sheet-like substrates 10A to 10C respectively, and control means (not shown) for controlling the drive of the tension rollers 76. Each tension roller 76 is configured so as to rotate in forward and backward directions for the alignment of the sheet-like substrates (described later), and can transport the sheet-like substrates in both directions. The laminating apparatus 70 also includes two guides 71 for laminating the three-layered sheet-like substrates 10A to 10C under the condition that they are in contact with each other.

In FIG. 5, although each guide 71 is shown merely schematically, the guide 71 may be composed of roller members that are opposed to each other with the three-layered sheet-like substrates placed therebetween, and come into a point contact with the respective upper and lower sheet-like substrates 10A and 10C, for example. The guide 71 may also have a mechanism for preventing the air from remaining between the sheet-like substrates. Further, the guide 71 may also have a mechanism for positioning the respective sheet-like substrates 10A to 10C with respect to the width direction of the sheet-like substrates, i.e., the direction orthogonal to the transport direction in a sheet plane.

In order to align the position of each sheet-like substrate, alignment marks 13 as shown in FIG. 6 are provided on each sheet-like substrate 10. Specifically, at least three alignment marks 13 are provided outside of a region to be punched out, or outside of an information recording region of a disk, and three alignment marks 13 are placed at an equal interval, for example, in a circumferential direction of the disk.

Depending upon the shape of the alignment marks, one alignment mark may be possible, and in this case, one alignment mark can be provided at the center of a substrate, and the position of each sheet can be adjusted so as to be matched with the alignment marks. Further, the sheets may also be laminated under the condition that they are aligned before being laminated, which is effective when an adhesive having no flowability is used.

The alignment marks 13 can be formed using, for example, the above-mentioned forming apparatus 20 (see FIG. 3). Specifically, projections for forming the alignment marks are provided outside an effective region of the stamper 23. Then, during the process of transcription by the stamper 23, the alignment marks 13 may be formed on the sheet-like substrate 10 together with a signal pattern 14.

The shape of the alignment marks 13 is not particularly limited, as long as they can be detected at high precision. Not only a cross-shape as shown but also a cross-shaped slit, a star shape, or the like may be used.

Referring to FIG. 5 again, two sensors 74 for detecting the above-mentioned alignment marks 13 are placed in a region between the two guides 71 as constituent elements of the laminating apparatus 70. The positional information of the alignment marks 13 detected by the sensors 74 is sent to the control means (not shown) of the laminating apparatus 70. The control means drives the tension rollers 76 and the like so as to center the respective sheet-like substrates 10A to 10C. The respective sheet-like substrates 10A to 10C thus aligned are held by the guides 71, which maintains an aligning state.

The punching apparatus 60 is a pressing machine for punching, placed in a region between the two guides 71, and punches the three-layered laminated sheet-like substrates 10A to 10C in a collective manner.

Specifically, the punching apparatus 60 includes a pair of press members 61a and 61b for sandwiching and punching the sheet-like substrates. The contour shape of the sheets to be punched by the pair of press members 61a and 61b is a disk-shape (i.e., a circle). With this, a laminate 50′ in which the three-layered sheet-like substrates 10A to 10C are laminated is produced.

Next, a method of manufacturing the optical recording medium 50 of this embodiment, and an operation of each of the above-mentioned apparatuses will be described with reference to FIGS. 7A to 7E. FIGS. 7A to 7E schematically show the sheet-like substrate 10 and the recording layer 16 without uneven patterns.

First, the sheet-like substrate 10 pulled out from the roll 19 (see FIG. 3) is sent to the forming apparatus 20 by the rollers 24. Under the condition that the drive of the rollers 24 is stopped, the forming apparatus 20 is driven. When the forming apparatus 20 is driven, the stamper 23 is pressed onto one surface of the sheet-like substrate 10, to thereby form a predetermined signal pattern 14 on the sheet-like substrate 10 (see FIG. 7A).

Then, the rollers 24 are driven again to transport the sheet-like substrate 10. This transport operation is performed until the formed signal pattern 14 is placed at a predetermined position in the film-forming apparatus 30. Then, by driving the film-forming apparatus 30, the recording layer 16 is formed on the surface of the signal pattern 14 (see FIG. 7B).

Then, for example, by allowing the sheet-like substrate 10 to pass through the adhesive coating apparatus 40A in FIG. 4A, the adhesive layer 42 with a predetermined thickness is formed on the sheet-like substrate 10 (see FIG. 7C). The adhesive layer 42 is formed on a surface of the sheet-like substrate 10 opposite to the recording layer 16.

Then, the sheet-like substrates 10A to 10C with the recording layer 16 and the adhesive layer 42 formed thereon are sent to the guides 71 of the laminating apparatus 70 via the tension rollers 76 (see FIG. 5). Herein, the three-layered sheet-like substrates 10A to 10C held by the two guides 71 are brought into contact with each other via the adhesive layers 42 as shown in FIG. 7D. At this time, the adhesive has not been cured. Thus, centering of each sheet-like substrate can be performed.

Specifically, in the contact state as shown in FIG. 7D, the sensors 74 of the laminating apparatus 70 detect the positions of the alignment marks 13 provided on each sheet-like substrate. Based on the detection results, the final positioning (centering) of the respective sheet-like substrates 10A to 10C is performed by the tension rollers 76 or the guides 71. Owing to this positioning, the centers of regions to be punched in the respective sheet-like substrates are aligned.

After the final positioning is completed, the adhesive layers 42 are cured. The process of curing the adhesive is determined depending upon the kind of an adhesive to be used. For example, in the case of using a thermosetting material, heating corresponds to the process.

Then, after the adhesive layer 42 is cured, the three-layered laminated sheet-like substrates are punched in a collective manner by driving the punching apparatus 60. With this, a laminate 50′ in which the three-layered sheet-like substrates 10A to 10C are laminated is produced (see FIG. 7D).

Then, as shown in FIG. 7E, the support substrate 17 with the signal pattern 14 and the recording layer 16 previously formed thereon, punched into a disk shape, and the laminate 50′ are bonded together via the adhesive layer 42 to obtain a laminated recording medium 55.

Then, the protective layer 58 is formed on the sheet-like substrate 10C on an uppermost surface side, to thereby the optical recording medium 50 of this embodiment is produced.

In the above, formation in a collective manner has been described. Hereinafter, the formation of the protective layer 58 for the purpose of obtaining a recording medium of higher quality will be described in more detail. Hereinafter, regarding the formation of the protective layer 58, a method using a sheet 100 and a method using liquid resin 121 will be described.

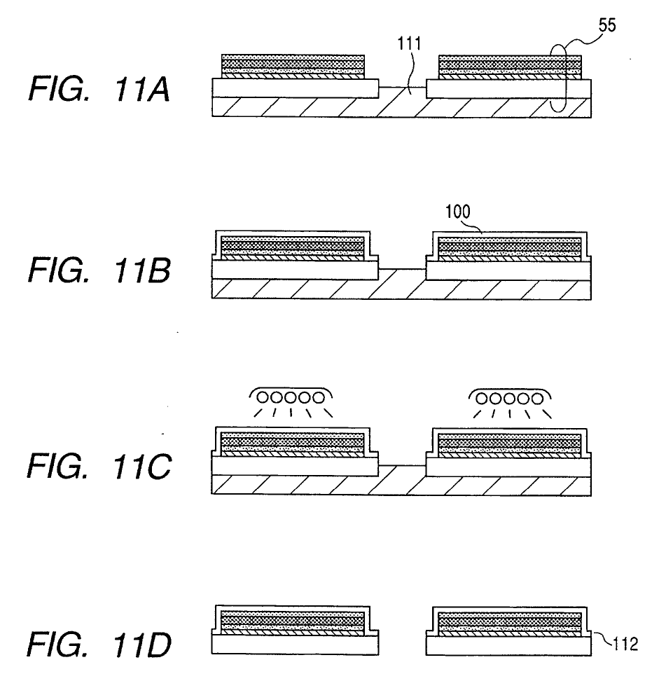

FIGS. 11A to 11D are views showing the process of forming a protective layer, using the sheet 100 made of resin. Hereinafter, the process of forming a protective layer, using the sheet 100, will be described in detail with reference to FIGS. 11A to 11D.

(1) The laminated recording medium 55 is set on a holding tool 111. A method of holding the laminated recording medium 55 is not particularly limited, and a method of holding an inner circumferential side with a drive mechanism, a method of holding several points with balls or the like attached to a spring by a point contact, and the like are considered (FIG. 11A).

(2) The protecting sheet 100 is placed over the held laminated recording medium 55 while care is taken so that air and a foreign matter are not involved. In order to bring the protecting sheet and the laminated recording medium into contact with each other without involving air and foreign matter, this process is desirably performed in vacuum. As the material for the substrate-side protecting sheet 100, various materials such as thermosetting resin and heat-shrinkable resin can be considered. Further, the material is not particularly limited and further various materials can be used as long as the material has an adhesive layer. A center hole may or may not be provided previously in the protecting sheet 100. The protecting sheet 100 is not particularly limited, and may be a single sheet or may be wound up in a roll shape considering productivity (FIG. 11B).

(3) The protecting sheet 100 and the laminated recording medium 55 are bonded together under the condition that they are in contact with each other. The bonding method may be performed in accordance with a material for the used protecting sheet. Further, it is desirable that, on an inner circumferential side of a recording medium, the bonded protective layer covers the entire recording layer, and does not protect a part of the support substrate. Thus, clamping is performed using a part of the support substrate not protected during reproduction of a signal. As a result, the eccentricity precision will not be impaired (FIG. 11C).

(4) The inner and outer circumferences are processed to an optical recording medium shape if required, thereby an optical recording medium with a multi-layered structure is completed. This process is required in the case where the center hole is not provided in the protecting sheet. The method of shape processing is not particularly limited, and methods such as punching with a pressing machine and laser processing are known (FIG. 11D).

FIG. 10A is a schematic cross-sectional view of a four-layered optical recording medium produced using sheets in the process of forming a protective layer. In the four-layered optical recording medium 112 produced using sheets in the process of forming a protective layer, the recording layers 16 are formed on the signal patterns of the sheet-like substrates 10A, 10B, 10C with the signal patterns formed thereon, and the signal pattern of the support substrate 17 with the signal pattern formed thereon. The above-mentioned sheets and the support substrate are laminated via the adhesive layers 42, and the laminate is protected by the protecting sheet 10.

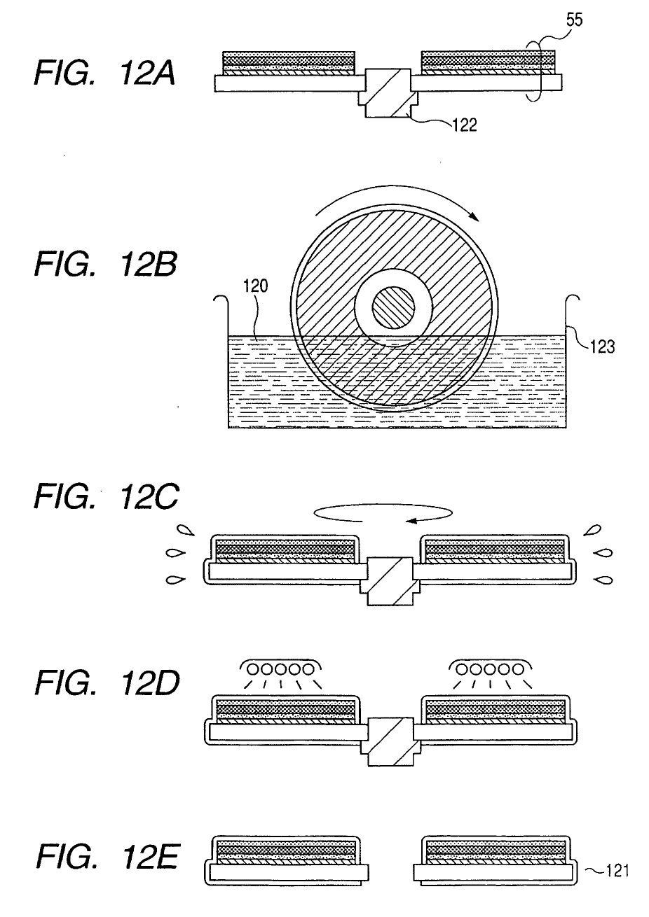

FIGS. 12A to 12E are views showing the process of forming a protective layer by immersing the disk in resin. Hereinafter, the process of forming a protective layer by applying resin will be described in detail.

(1) The laminated recording medium 55 is set on a holding tool 122. In the same way as described in a first embodiment of the present invention, a method of holding the laminated recording medium 55 is not particularly limited, and a method of holding an inner circumferential side with a drive mechanism, a method of holding several points with balls or the like attached to a spring by a point contact, and the like are considered.

(2) The held laminated recording medium 55 is allowed to pass through a tank 123 filled with resin for a protective layer 120 while the held laminated recording medium 55 is being rotated at a constant rotation number. At this time, it is desired that the resin is not in contact with an inner circumferential side wall. Thus, the occurrence of burr caused by the effect of the resin for a protective layer on an inner circumferential side can be prevented, thereby the eccentricity precision will not be impaired. The resin for a protective layer 120 is not particularly limited, and an example thereof includes a UV-curable resin and the like. The resin having sufficient hardness after being cured is desired in terms of the role as a protective layer.

(3) After immersing, the thickness of the resin for a protective layer 120 is controlled. A method of controlling a thickness is not particularly limited, and a method of controlling a medium rotation number in accordance with the viscosity of the resin for a protective layer and adjusting the thickness of a protective layer, and a method of pulling up a dipped medium at a low speed are known.

(4) The resin for a protective layer is cured by a method in accordance with the material for the resin for a protective layer, such as the irradiation of UV and heating.

(5) The optical recording medium is removed from the holding tool 122, thereby the optical recording medium 121 is completed. FIG. 10B is a schematic cross-sectional view of the four-layered optical recording medium produced by immersing the disk in resin in the process of forming a protective layer. In the four-layered optical recording medium 121 produced by applying resin in the process of forming a protective layer, the recording layers 16 are formed on the signal patterns of the sheet-like substrates 10A, 10B, and 10C with the signal patterns formed thereon, and the signal pattern of the support substrate 17 with the signal pattern formed thereon. The above-mentioned sheets and the support substrate are laminated via the adhesive layers 42, and the laminate is protected by the resin for a protective layer 120.

As described above, according to the manufacturing method of this embodiment, the three-layered sheet-like substrates 10A to 10C aligned with respect to each other by the laminating apparatus 70, and fixed in an aligning manner are punched into a disk shape by the punching apparatus 60 in a collective manner. Therefore, the positional shift of the respective sheet-like substrates 10A to 10C, in other words, the positional shift of the recording layers 16 of the sheet-like substrates is minimized, and consequently, the highly reliable optical recording medium 50 with the eccentricity suppressed is obtained.

Further, according to the manufacturing method of this embodiment, the three-layered sheet-like substrates 10A to 10C are laminated concurrently, i.e., the respective sheet-like substrates are not laminated one by one. Therefore, the production process is simplified.

The punching of the sheets into a disk is not necessarily performed after the adhesive is cured. For example, depending upon the shape of a press die and the like, it may be easier to obtain the adhesive layer 42 with a uniform thickness by punching the sheets after the adhesive is cured.

Further, on the side surface of the plurality of laminated plurality of sheet bases, a sheet made of resin or liquid resin is used as a protective layer. This can protect the side surface of the sheet-bases from being degraded due to corrosion, and a multi-layered optical recording medium having higher quality and higher durability can be obtained.

### EXAMPLE 1

Hereinafter, a specific example of the present invention will be described with reference to FIGS. 1, 2, 3, 4A to 4C, 5, 6, and 7A to 7E.

As the sheet-like substrates 10A, 10B, and 10C made of polycarbonate, those having thicknesses of 12 μm, 13 μm, and 14 μm, respectively, were prepared. A protective sheet with a thickness of 100 μm was laminated on one surface of each sheet-like substrate as a backing member.

The glass transition point of polycarbonate resin was 140° C., and the thermal deformation temperature thereof was about 120° C. Further, the temperature of the sheet-like substrates immediately after the transcription by the stamper 23 of the forming apparatus 20 was 30° C. to 40° C.

In the film-forming apparatus 30, a SiN film (reflective layer) was formed as the recording layer 16 by sputtering, and the thickness thereof was 10 nm. In the process of sputtering, a mask was used so that the alignment marks 13 were not formed.

The transmittance of light regarding the respective recording layers 16 in the sheet-like substrates can be changed by adjusting the pressure during film formation, the glass flow rate, and the supply power without changing the thickness. In the present example, the transmittance of the four-layered recording layers 16 was set so as to increase from the support substrate 17 side to the outermost surface side in the final optical recording medium 50 state.

As the adhesive 48, a thermosetting adhesive was used, and the adhesive layer 42 was formed using the adhesive coating apparatus 40B shown in FIG. 4B. The thickness of each adhesive layer 42 was about 3 μm. After the adhesive was applied, the protecting sheet of the sheet-like substrates was peeled.

The interlayer distance between the recording layers 16 is defined by the total of the thickness of the adhesive layer 42 and the thickness of the sheet-like substrate 10. In the present example, the interlayer distance is adjusted using the sheet-like substrate 10. More specifically, as described above, the thickness of the adhesive layer is set to be very small (i.e., about 3 μm), and on the other hand, the thickness of the sheet-like substrate is set to be tens of μm. The thickness of the adhesive layer is likely to fluctuate compared with the thickness of the sheet-like substrate. Therefore, making the adhesive layer thin in this manner is advantageous because the uniformity of the final interlayer distance can be enhanced. The interlayer distance can be adjusted easily only by changing the thickness of each sheet-like substrate.

The contour shape of a disk to be punched by the punching apparatus 60 was set to be an outer diameter of 120 mm and an inner diameter of 12 mm. Further, the support substrate 17 (thickness: 1.1 mm) made of polycarbonate previously processed into the above-mentioned shape was placed under the three-layered sheet-like substrates in the punching apparatus 60.

On the support substrate 17, a signal pattern 14 and a recording layer 16 were formed in a separate step. Further, by keeping the inside of the punching apparatus 60 in a vacuum state, air or a foreign matter was prevented from remaining between the respective sheet-like substrates.

Then, the three-layered sheet-like substrates were laminated by the laminating apparatus 70, and the three-layered sheet-like substrates 10A to 10C were punched in a collective manner by the punching apparatus 60. Thereafter, the support substrate 17 was bonded to a lower surface of the sheet-like substrate 10C. In the present example, the step of curing the adhesive layer 16 (an adhesive layer for attaching the three-layered sheet-like substrates) was performed before the punching step.

Owing to the above step, a structure in which the three-layered sheet-like substrates 10A to 10C and the support base 17 were laminated was obtained. After this, a protective layer 58 made of UV-curable resin was formed into a thickness of 75 μm on an upper surface of the sheet-like substrate 10C on an uppermost surface side (strictly, on an upper surface of the recording layer 16 thereof). Because of this, the optical recording medium according to this example was obtained. The process of providing the protective layer 58 will be described later.

When information recorded on each recording layer 16 was reproduced from the protective layer 58 side of the optical recording medium thus produced, reproduction was performed without any problem in each layer.

This embodiment and the present example have been described. However, the present invention is not limited to the above description, and can be variously modified.

For example, the material for the sheet-like substrate 10 is not particularly limited as long as it does not cause any problem optically in recording, reproducing, or erasing information with respect to the recording layer 16. In place of polycarbonate, for example, polyolefin resin or acrylic resin can be used as thermoplastic resin. Recently, the wavelength of light to be used is being shorter (i.e., 785 nm in a CD, and 660 nm in a DVD), and further, 405 nm has been studied in a Blu-ray Disk. In view of this, it is preferable to use a material that less absorbs or reflects light in these wavelength regions, and is unlikely to cause birefringence. Further, although the thickness of the sheet-like substrate 10 can be arbitrarily selected in a range of about 1 μm to 300 μm, it is preferably selected appropriately, considering the number of the recording layers 16 and the dynamic range of a spherical aberration correcting mechanism.

Further, the interlayer distance can also be adjusted by using, as an intermediate layer, a flat sheet-like substrate without the signal pattern 14 and the like formed thereon. Alternatively, such a flat sheet-like substrate can also be used as the support substrate 17 or the protective coat layer 58. Thus, in the case of using a sheet-like substrate as the protective layer 58, the protective layer 58 as well as the three-layered sheet-like substrates 10A to 10C are laminated, and under this condition, these layers may be punched in a collective manner by driving the punching apparatus 60.

In the above embodiment, the sheet-like substrate 10 is wound around the roll 19. The structure in which a sheet is pulled out from the roll 19 is preferable in terms of the enhancement of productivity. However, the present invention is not limited thereto. For example, sheets cut to a predetermined size may be successively supplied to the forming apparatus 20 and the like. The shape of each sheet may be, for example, rectangular or circular. Further, there is no particular limit to the presence/absence of a center hole. The shape of the sheet is not particularly limited as long as it does not cause any problem in positioning and transportation.

In FIG. 2, although two rollers 24 are shown as the transport means, a belt conveyer or an industrial transport robot can also be used as the transport means, in place of the rollers 24.

The method of forming the signal pattern 14 may be as follows in place of the above.

More specifically, instead of forming a signal pattern directly on the sheet-like substrate 10, a film made of any of UV-curable resin, thermosetting resin, or a dry photopolymer, with a signal pattern formed thereon, can also be laminated on the sheet-like substrate 10. Further, uncured (liquid) or semi-cured (sheet-shaped) resin can also be placed on a stamper, cured, and can be bonded to a sheet-like substrate. In this case, as the above-mentioned resin, UV-curable resin, thermosetting resin, or a dry photopolymer may be used. As a material for the UV-curable resin, thermosetting resin, or dry photopolymer, acrylic, epoxy, urethane, phenol, or other various kinds of modified materials can be used. However, it is preferable to select a material that less absorbs light in the above wavelength range, in particular, a material whose absorption range of the initiation of photopolymerization is different from the wavelength range used for recording, reproducing, or erasing. Further, it is preferable that a peelable protective sheet is placed on one surface of resin in a later step. When the protective sheet is placed, the stamper presses resin via the protective sheet, whereby the thickness of a sheet to be formed can be made uniform. Further, when the protective sheet is placed, the rigidity of a sheet is substantially enhanced, so that the advantage of the enhancement of the transportation and handling of a sheet is obtained.

A method of using such a protective sheet can be applied variously. For example, the following is possible: in a predetermined step, a protective sheet is temporarily bonded to the sheet-like substrate 10, whereby the handling is enhanced in that step. This may enhance the positioning precision of the sheet-like substrate 10. When the protective sheet is peeled, static electricity is generated, and dust may be attached thereto. Therefore, it is preferable that a peeling operation is performed using an anti-static protective sheet or in an antistatic environment.

A method of forming the recording layer 16 is not particularly limited, and vapor deposition, CVD, dip coating, spin coating, or the like can be used in place of sputtering.

As the material for the optical recording layer, an alloy or the like made of at least one kind of materials such as Te, In, Ga, Sb, Se, Pb, Ag, Au, As, Co, Ni, Mo, W, Pd, Ti, Bi, Zn, and Si is generally known widely. A number of materials have already been present as a known technique.

In addition to the above, as a magnetooptical recording material, an alloy made of at least one kind of materials such as Tb, Fe, Co, Cr, Gd, Dy, Nd, Sm, Ce, Ho, and the like, and a rare earth—transition metal alloy are used in a large number, and a number of these materials have already been present as a known technique.

As a material for the reflective layer dedicated for reproduction, Al, an Al alloy, Si, SiN, Ag, an Ag alloy, or the like is used, and a number of materials have already been present as a known technique. Further, an organic coloring material such as cyanine, phthalocyanine, and azo type can also be used as a recording layer.

Although the thickness of the above-mentioned recording layer or reflective layer can be set arbitrarily, the attenuation of light is caused in each recording layer and reflective layer from a light incident surface side. Therefore, it is desirable to increase the transmittance at a wavelength of light to be used in a layer closer to an incident surface side, and it is preferable that the composition and the thickness of each recording layer and reflective layer are adjusted, whereby recording, reproduction, and deletion of each layer is not impaired. By optimizing the composition, thickness, film-formation condition, and the like for each sheet-like substrate and each support substrate, a recording layer and a reflective layer with an arbitrary transmittance and a reflectance can be formed.

In FIGS. 4A to 4C, a method of applying an adhesive to the sheet-like substrate 10, in other words, a method of forming the adhesive layer 42 is described. However, instead of using the apparatuses as shown in FIGS. 4A to 4C, the adhesive layer 42 can also be formed by attaching a sheet-shaped member functioning as the adhesive layer 42 to the sheet-like substrate 10. Further, a sheet-like substrate with an adhesive layer formed previously on one surface (on an opposite side of the recording layer 16) may be used. Further, the adhesive layer can also be formed on both side surfaces of the sheet-like substrate 10.

In the above embodiment, although the adhesive layer 42 is previously formed before the punching step, the adhesive layer 42 can also be formed after punching.

More specifically, the respective sheet-like substrates 10A to 10C and the support substrate 17 are laminated without interposing the adhesive layer 42 therebetween, and aligned. Under this condition the sheet-like substrates 10A to 10C are punched. As a result, the sheet-like substrates 10A to 10C become a disk shape, and each of the sheet-like substrates and the support substrate has a center hole.

Then, the center hole is clamped, and the respective sheet-like substrates and the support substrate are held under the condition that the sheet-like substrates 10A to 10C are aligned. After this, an adhesive is allowed to permeate between the respective sheet-like substrates or the like from a disk outer circumferential portion, and the adhesive is cured under the condition that the sheet-like substrates are pressed from both surface sides. Consequently, the adhesive layer 42 is formed between the sheet-like substrates.

In order to realize the above-mentioned step of permeation of an adhesive, it is necessary to keep a gap so as to allow an adhesive to permeate between the sheet-like substrates and the like under the clamped condition.

According to the above-described method, the size of a gap under the clamped state does not change, so that the adhesive layer 42 is formed with the interlayer distance being constant. Because of this, the thickness of the adhesive layer 42 is not likely to vary, and consequently, the uniformity of an interlayer distance can be enhanced.

A method of punching a disk may be a method using laser processing and mechanical cutting, as well as a method using a press die (the punching apparatus 60 of FIG. 5). The contour shape of an optical recording medium is not limited to a disk shape (circle), and may be a polygonal shape such as a rectangle.

Further, the timing of driving the punching apparatus 60 can also be changed, and in the above, it is described that punching is performed after the adhesive layer 42 is cured. However, the adhesive layer 42 may be cured after the sheet-like substrates are punched.

The laminating apparatus 70 may laminate the respective sheet-like substrates in a vacuum environment so as to prevent air or a foreign matter from being mixed between sheets, when the respective sheet-like substrates are laminated. Further, the laminating apparatus may include a pair of plate-shaped press members for pressing and holding the three-layered laminated sheet-like substrates from both surface sides. Because of this, the sheet-like substrates are pressed with a substantially uniform force in the laminated region, and consequently, the uniformity in thickness of the adhesive layer can be enhanced. Punching may also be performed under the pressed state.

Further, various methods can be adopted for bonding the laminate 50′ (see FIG. 5) and the support substrate 17. For example, the laminated three-layered sheet-like substrates, and the support substrate 17 before being punched are laminated, and under this condition, they may be punched into a disk in a collective manner.

Film formation may be performed in the alignment marks 13. This is because the reflectance is enhanced owing to film formation to increase reading precision, depending upon the system of reading the alignment marks. It is preferable to provide a plurality of the alignment marks 13 outside an effective region of a disk or in a region to be cut during punching, in terms of the enhancement of a positional precision. Only one alignment mark 13 may be used. In this case, for example, one alignment mark is provided at the center portion of a disk, and each sheet-like substrate may be aligned so as to be matched with the alignment mark.

Further, in the above embodiment, it is described that the respective sheet-like substrates are laminated, and thereafter, they are aligned. However, centering may also be performed before the respective sheet-like substrates are laminated, i.e., before the respective sheet-like substrates come into contact with each other. In this case, the guides 71 may be configured so as to bring the respective centered sheet-like substrates into contact with each other while they are being centered. Such the method of centering and laminating is advantageous in the case where the adhesive has no flowability or in the case where the adhesive has low flowability.

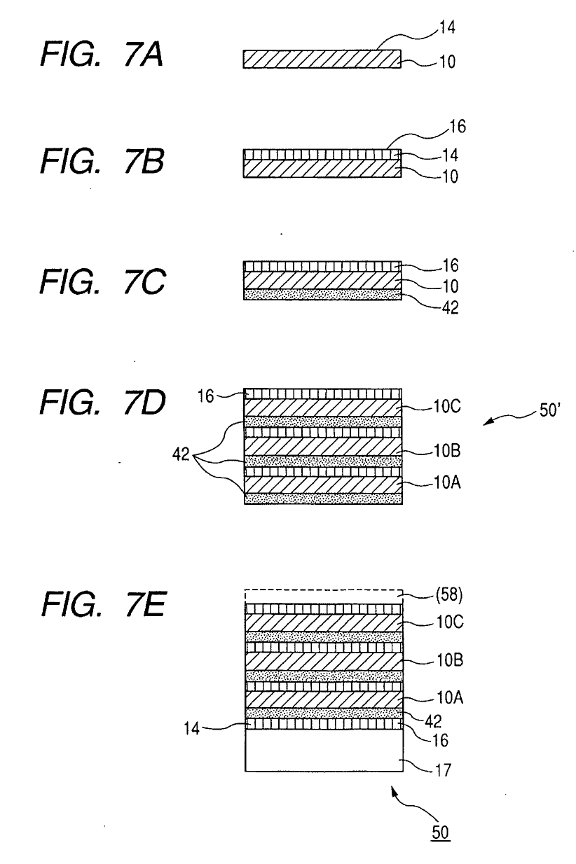

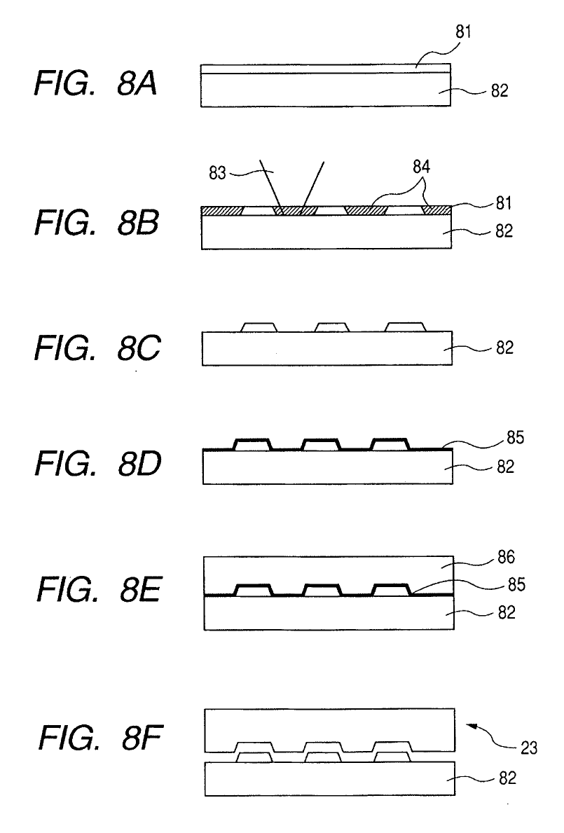

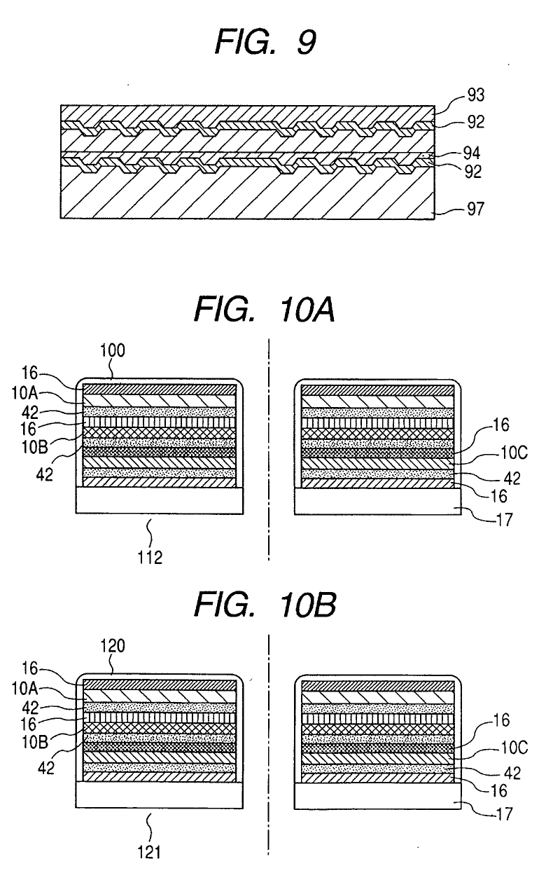

Although the stamper 23 can be produced by a conventionally known method, for a reference, an exemplary process of manufacturing the stamper 13 will be described with reference to FIGS. 8A to 8F.

First, as shown in FIG. 8A, a photoresist 81 is applied to a master glass 82 by spin coating. Then, as shown in FIG. 8B, the photoresist 81 is irradiated with a laser 83, whereby a signal pattern with a predetermined shape is formed as a light-exposed portion 84.

Then, as shown in FIG. 8C, the light-exposed portion 84 is subjected to alkali development to allow a predetermined signal pattern to remain on the master glass 82. Then, as shown in FIG. 8D, a nickel conductive film 85 is formed on the signal pattern surface and the like. This film formation can be performed, for example, by sputtering. Then, as shown in FIG. 8E, an electroformed layer 86 with a thickness of, for example, 0.3 mm is formed on the master glass 82 by performing nickel electroforming. Then, an entire reverse surface (upper surface of the figure) of the electroformed layer 86 is polished, and thereafter, as shown in FIG. 8F, the electroformed layer 86 is peeled from the master glass 82. Because of this, the stamper 23 with a predetermined signal pattern transcribed thereon is produced.

### EXAMPLE 2

Next, the step of providing the protective layer 58 on the laminated recording medium 55 in which the laminate 50′ and the support substrate 17 are bonded together will be described in detail.

FIGS. 11A to 11D schematically show the process of forming a protective layer in the case of using a sheet 100 for forming a protective layer in a method of manufacturing an optical recording medium according to the present invention.

First, the laminated recording medium 55 was held on the holding tool 111. The protecting sheet 100 was placed in vacuum on the recording layer side of the held laminated recording medium 55 so as not to involve air and a foreign matter between the laminated recording medium 55 and the protecting sheet 100. As the protecting sheet is made of thermoplastic resin, a sheet with a thickness of 75 μm was used. A center hole was provided in the used protecting sheet, and the inner/outer diameters thereof completely covered the recording layer in an outer circumferential portion of the optical recording medium. In the inner circumferential portion, in order to prevent the protecting sheet from extending off the inner diameter of the support substrate 17 to become burr, the outer diameter and the inner diameter were set to be 121.0 mm and 14.0 mm, respectively

The laminated recording medium 55 and the protecting sheet 100 were heated entirely under the condition that they were in contact, whereby the protecting sheet 100 and the laminated recording medium 55 were bonded. The heating temperature during bonding was 110° C.

After bonding, the laminated recording medium 55 was peeled from the holding tool 111, whereby the four-layered optical recording medium 112 produced in accordance with the first embodiment was completed.

FIGS. 10A and 10B are schematic cross-sectional views of the four-layered optical recording medium 112 produced according to the present example. In the four-layered optical recording medium 112 produced in accordance with the present example, the sheet-like substrates (10A, 10B, and 10C) with a signal pattern formed thereon were laminated via the adhesive layers 42 and punched. Then, the recording layer 16 was formed on a signal pattern of the support substrate 17 with a signal pattern formed thereon. Then, the above-mentioned laminated sheets were laminated on the support substrate 17 via the adhesive layer 42, whereby the laminate was protected by the protecting sheet 100, whereby the four-layered optical recording medium 112 was completed.

By forming a protective layer using a sheet in accordance with the present example, the thickness can be controlled with high precision without impairing productivity. Further, a protective layer can be provided also on a side surface on an outer circumferential side of the optical recording medium where the corrosion of the reflective layer and the recording layer caused by moisture absorption and peeling caused by tearing are generally likely to occur. Thus, the present example was allowed to have high durability with respect to moisture absorption and tearing. Further, when information was reproduced from the protecting sheet on the recording layer side of the completed four-layered optical recording medium 112, information was produced without any problem in each layer.

### EXAMPLE 3

Further, a four-layered optical recording medium was produced by a procedure of forming the protective layer 58 by immersing in resin. The formation of the protective layer will be described below in detail.

FIG. 12A to 12E schematically show the process of forming a protective layer by immersing in resin, in the method of manufacturing an optical recording medium according to the present invention.

The laminated recording medium 55 was held on the holding tool 122 (see FIG. 12A).

The held laminated recording medium 55 was allowed to pass through the tank 123 filled with the resin for a protective layer 120 while the held laminated recording medium 55 was being rotated. UV-curable resin (INC-118, produced by Nippon Kayaku Co., Ltd.) was used as the resin for a protective layer, and the rotation number during immersing was set to be 60 rpm, and the immersing time was set to be 2.0 seconds. Further, as shown in FIG. 12B, only a region from a radius of 8.0 mm to the outermost circumference was dipped so that the inner circumferential side of the laminated recording medium 55 was not dipped in the resin for a protective layer.

The thickness of the resin for a protective layer 120 was controlled by spinning the dipped laminated recording medium 55. The number of rotation of the spin was set to be 1250 rpm, and the thickness of the protective layer was controlled to be 75 μm (see FIG. 12C).

After the thickness was adjusted, the resin for a protective layer was cured by irradiation of UV (see FIG. 12D), and peeled from the holding tool 122, whereby the four-layered optical recording medium 121 produced in accordance with the second embodiment was completed (see FIG. 12E).

FIG. 10B is a schematic cross-sectional view of the four-layered optical recording medium 121 produced according to the present example. In the four-layered optical recording medium 121 produced in accordance with the present example, the sheet-like substrates (10A, 10B, and 10C) with a signal pattern formed thereon were laminated via the adhesive layers 42 and punched. Then, the recording layer 16 was formed on a signal pattern of the support substrate 17 with a signal pattern formed thereon. Then, the above-mentioned laminated sheets were laminated on the support substrate 17 via the adhesive layer 42, whereby the laminate was protected by the protecting sheet 120, whereby the four-layered optical recording medium 121 was completed.

A protective layer was formed by immersing in liquid resin in accordance with the present example. Because of this, in an outer circumferential portion of a recording medium where the corrosion of a reflective film and a recording film caused by moisture absorption and peeling caused by tearing are generally likely to occur, the seamless protective layer 58 was formed. Durability was also enhanced. In the production process, bubbles and a foreign matter were easily removed without forming a protective layer in vacuum. The resin for a protective layer shaken off by spinning was further re-used, so that the resin for a protective layer was not wasted, and a plurality of sheets were dipped in resin together, which realized a decrease in cost and an enhancement of productivity.

When information was reproduced from the recording layer side of the completed four-layered optical recording medium, information was reproduced without any problem in each layer.

This application claims priority from Japanese Patent Application Nos. 2005-036110 filed Feb. 14, 2005, and 2005-155533 filed May 27, 2005, which are hereby incorporated by reference herein.

What is claimed is:

1. A method of manufacturing a recording medium, comprising the steps of:
forming a recording layer having uneven patterns on a surface of a sheet-like substrate;
laminating a plurality of the sheet-like substrates having the recording layer formed thereon in an aligning manner; and
processing the plurality of laminated sheet-like substrates into a predetermined contour shape in a collective manner.

2. The method of manufacturing a recording medium according to claim 1, wherein after the step of laminating and before the step of processing, an adhesive is allowed to permeate to be cured between the sheet-like substrates while the sheet-like substrates are aligned, to thereby bond the plurality of sheet-like substrates together.

3. The method of manufacturing a recording medium according to claim 2, further comprising the step of bonding a support substrate to one of outermost layers of the bonded plurality of sheet-like substrates through an intermediation of an adhesive layer.

4. The method of manufacturing a recording medium according to claim 1, wherein after the step of processing, a protective layer is formed on a side surface of the plurality of sheet-like substrates.

5. The method of manufacturing a recording medium according to claim 4, wherein the protective layer is formed using a sheet made of resin or a liquid resin.

6. The method of manufacturing a recording medium according to claim 1, wherein the alignment is performed using an alignment mark provided outside of an information recording region of the recording medium.
